(19) United States
(12) Patent Application Publication
(10) Pub. No.: US 2025/0312234 A1
(43) Pub. Date: Oct. 9, 2025

(54) BREAST MASSAGER

(71) Applicant: Shenzhen Lute Jiacheng Supply Chain Management Co., Ltd., Shenzhen (CN)

(72) Inventors: Rongjun LI, Shenzhen (CN); Zhen ZENG, Shenzhen (CN)

(73) Assignee: Shenzhen Lute Jiacheng Supply Chain Management Co., Ltd., Shenzhen (CN)

(21) Appl. No.: 19/241,658

(22) Filed: Jun. 18, 2025

Related U.S. Application Data
(63) Continuation-in-part of application No. 18/501,341, filed on Nov. 3, 2023, now abandoned.

(30) Foreign Application Priority Data
Sep. 28, 2023 (CN) 202322687789.X

(51) Int. Cl. A61H 23/02

(52) U.S. Cl. CPC A61H 23/02; A61H 2201/02; A61H 2205/082

(57) ABSTRACT

A breast massager includes a housing. The housing includes a first contact surface and a second contact surface for applying the treatment function to the breast; the first contact surface includes a first treatment portion, and the second contact surface includes a second treatment portion; at least one of the first treatment portion and the second treatment portion is a cold compress treatment portion for applying a cold compress treatment to the breast. The first contact surface and the second contact surface are provided in two different directions of the housing, so that the first treatment portion and the second treatment portion do not interfere with each other when they apply the treatment function to the breast simultaneously.

### CROSS-REFERENCE TO RELATED APPLICATIONS

This application is a continuation-in-part of U.S. patent application Ser. No. 18/501,341, filed on Nov. 3, 2023, entitled “BREAST MASSAGER”, which claims priority to Chinese Patent Application No. 202322687789.X, filed on Sep. 28, 2023. All of the aforementioned applications are incorporated herein by reference in their entireties.

### TECHNICAL FIELD

The present application relates to the technical field of health care equipment, and in particular to a breast massager.

### BACKGROUND

The main function of the existing breast massager is vibration massage to promote lactation and milk discharge, and solve problems such as milk stasis and mastitis for breastfeeding mothers. However, it cannot solve physiological breast congestion, swelling and other problems. At this time, breastfeeding mothers during pregnancy need to use cold compresses for breast care. The main material of cold compresses is gel, which needs to be frozen in the refrigerator before use, which is cumbersome to operate and wastes time.

### SUMMARY

The main purpose of the present application is to provide a breast massager which can perform cold compress care on breasts and is easy and quick to operate, thereby improving the user's experience.

To achieve the above purpose, the present application provides a breast massager, configured for applying treatment function to a breast, and the breast massager includes: a housing;
the housing includes a first contact surface and a second contact surface for applying the treatment function to the breast;
the first contact surface includes a first treatment portion, and the second contact surface includes a second treatment portion;
at least one of the first treatment portion and the second treatment portion is a cold compress treatment portion for applying a cold compress treatment to the breast; and
the first contact surface and the second contact surface are provided in two different directions of the housing, so that the first treatment portion and the second treatment portion do not interfere with each other when they apply the treatment function to the breast simultaneously.

In an embodiment, the first treatment portion is the cold compress treatment portion, and the second treatment portion is a hot compress treatment portion.

In an embodiment, the breast massager further includes: a cooling apparatus; and a heating apparatus,
the cooling apparatus is provided in the housing and connected to the cold compress treatment portion, and the heating apparatus is provided in the housing and connected to the hot compress treatment portion.

In an embodiment, the cooling apparatus includes a refrigeration piece and a heat dissipation module, the refrigeration piece is provided in the housing and connected to the cold compress treatment portion, and the heat dissipation module is connected to one end of the refrigeration piece away from the cold compress treatment portion and is configured for dissipating heat generated by the refrigeration piece.

In an embodiment, the heating apparatus includes:
a hot compress outer shell connected to the housing and spaced apart from the cooling apparatus; and
a heating member provided between an inner wall of the hot compress outer shell and the housing, and configured to heat the hot compress outer shell.

In an embodiment, the first contact surface and the second contact surface are provided at two isolated surfaces of the housing.

In an embodiment, a heat insulation structure is provided between the hot compress treatment portion and the cold compress treatment portion, and the heat insulation structure is configured to separate the hot compress treatment portion and the cold compress treatment portion.

In an embodiment, the first contact surface is provided with a protrusion mounting position, and the protrusion mounting position is provided with the cold compress treatment portion.

In an embodiment, a plurality of protrusion mounting positions are distributed at a surface of the housing, and each of the protrusion mounting positions is provided with the cold compress treatment portion.

In an embodiment, the cold compress treatment portion is provided at one end of the housing.

In an embodiment, the housing is further provided with an air intake hole and a heat dissipation hole communicated with an external environment, and a ventilation path is formed between the air intake hole and the heat dissipation hole; and
the heat dissipation module includes a heat dissipation piece connected to the refrigeration piece and a fan, both the heat dissipation piece and the fan are provided in the ventilation path, and the fan is configured to dissipate a heat of the heat dissipation piece to the external environment.

In an embodiment, the heat dissipation module further includes an air duct housing provided in the housing and connected to a hot end of the refrigeration piece;
the air duct housing is communicated with the air intake hole and the heat dissipation hole to form the ventilation path; and
an outer wall of the fan is sealed and abutted against an inner wall of the air duct housing to drive a fresh air to flow from the air intake hole, the ventilation path and the heat dissipation hole in sequence.

In an embodiment, a discharge side of the fan is towards the heat dissipation piece.

In an embodiment, the housing is a curved structure, a bottom of the housing is a concave side of the curved structure, and the second treatment portion is provided at the concave side.

In an embodiment, one of the first treatment portion and the second treatment portion is the cold compress treatment portion, and another of the first treatment portion and the second treatment portion is a massage treatment portion.

In an embodiment, the massage treatment portion includes:
a vibration motor provided in the housing; and
a conduction rubber, one end of the conduction rubber is connected to an output shaft of the vibration motor, and the other end of the conduction rubber is connected to the housing in a transmission manner; and
the vibration motor is configured to drive the conduction rubber to vibrate, so that the housing is driven to vibrate by the conduction rubber to perform a massage operation to the breast.

In the technical solution of the present application, the breast massager includes a housing, and the housing has two contact surfaces with different orientations, which are the first contact surface and the second contact surface. The first treatment portion is provided at the first contact surface, and the second treatment portion is provided at the second contact surface. At least one treatment portion is the cold compress treatment portion. The two contact surfaces are staggered in spatial orientation to ensure that the treatment functions do not interfere with each other when being implemented. By arranging the first contact surface and the second contact surface in different orientations of the housing, the treatment portions of different treatment functions are separated in physical space, and functional interference is fundamentally eliminated, so that users can enjoy the dual treatment of cold compress and hot compress at the same time, or the combined treatment of cold compress and vibration massage, so that multiple treatment portions will not interfere with each other when implementing treatment at the same time, and ensure that cold compress and other treatment functions operate independently, so as to meet the user's demand for efficient and comfortable treatment experience, and improve the treatment efficiency and comfort.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic three-dimensional structural view of a breast massager according to an embodiment of the present application.

FIG. 2 is a schematic side view of the breast massager in FIG. 1.

FIG. 3 is a schematic cross-sectional view of the breast massager in FIG. 1.

FIG. 4 is a schematic bottom view of the breast massager in FIG. 1.

FIG. 5 is a module block view of the breast massager in FIG. 1.

FIG. 6 is a top view of a breast massager according to an embodiment of the present application.

FIG. 7 is a bottom view of the breast massager according to an embodiment of the present application.

FIG. 8 is a longitudinal cross-sectional view of the breast massager according to an embodiment of the present application.

FIG. 9 is an exploded structural view of the breast massager according to an embodiment of the present application.

FIG. 10 is a longitudinal cross-sectional view of a cooling apparatus of the breast massager according to an embodiment of the present application.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that all directional indications (such as up, down, left, right, front, back, etc.) in the embodiments of the present application are only used to explain the relative positional relationship, the movement situation, etc. among various assemblies under a certain posture as shown in the drawings. If the specific posture changes, the directional indication also changes accordingly.

In addition, the descriptions of “first”, “second”, etc. in the present application are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in this application.

The main function of the existing breast massager is vibration massage to promote lactation and milk discharge, and solve problems such as milk stasis and mastitis for breastfeeding mothers. However, it cannot solve physiological breast congestion, swelling and other problems. At this time, breastfeeding mothers during pregnancy need to use cold compresses for breast care. The main material of cold compresses is gel, which needs to be frozen in the refrigerator before use, which is cumbersome to operate and wastes time.

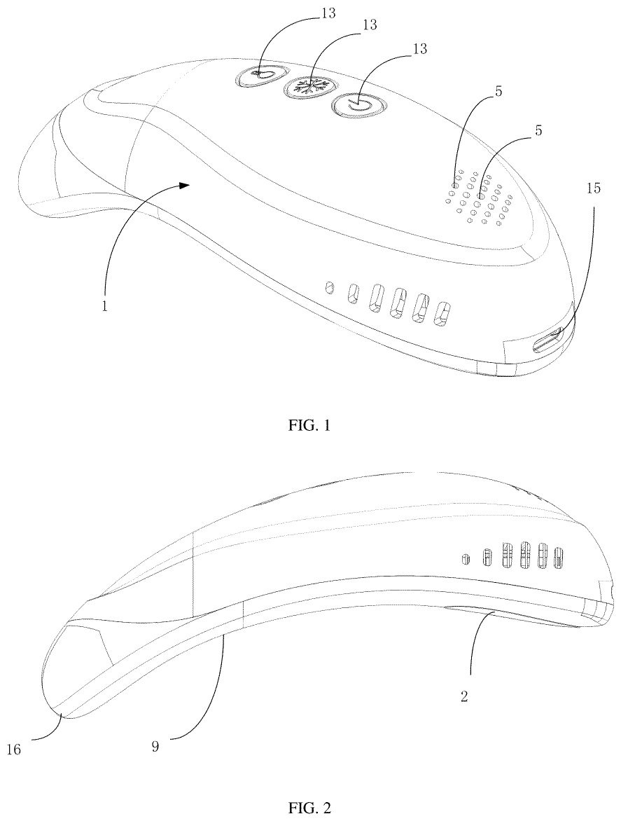

In view of this, the present application provides a breast massager which can perform cold compress care on breasts, and is easy and quick to operate, improving the user's experience. FIG. 1 to FIG. 5 are embodiments of the breast massager provided by the present application.

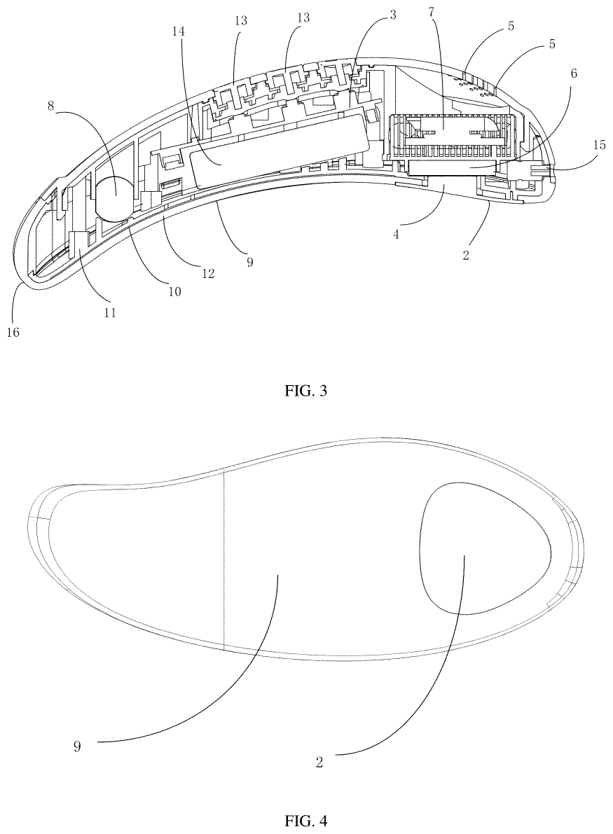

In an embodiment of the present application, referring to FIG. 1 to FIG. 5, with emphasis on FIG. 3, the breast massager 100 includes a housing 1, a cold compress component (see specifically the semiconductor refrigeration piece 4 in FIG. 3), at least one massage component (see the vibration motor 8 in the figure for details) and a control module 3. A side surface of the housing 1 is provided with a cold compress area 2; the massage component is provided in the housing 1 and is configured to perform massage operations on breasts; the cold compress component is provided in the housing 1 to provide cooling to the cold compress area 2; the control module 3 is provided in the housing 1, and the control module 3 is electrically connected to the cold compress component.

It should be noted that in addition to the side surface of the housing 1, the cold compress area 2 can also be provided on other surfaces or arc areas of the housing 1. In an embodiment, the cold compress area 2 is provided on at least one of the surfaces and arc areas of the housing 1, which is not limited in the present application.

In the technical solution of the present application, the breast massager 100 includes the housing 1, the cold compress component, at least one massage component and the control module 3. The side surface of the housing 1 is provided with the cold compress area 2. When breast congestion or swelling occurs, the control module 3 controls the cold compress component to provide cooling to the cold compress area 2. After cooling, the cold compress area 2 fits the breasts for cold compress, and there is no need to take another cold compress patch for freezing before nursing. The breast massager 100 has a cold compress function, can perform cold compress care on the breasts, and is easy and quick to operate, thereby improving the user's experience.

It should be supplemented that in the present application, the housing 1 is used as an installation carrier of the cold compress component, the massage component and the control module 3, and the specific structure of which is not limited. The housing 1 can be a cavity structure, which provides an installation space for the cold compress component, the massage component and the control module 3, and the side surface of the housing 1 refers to an outer side surface of a cavity wall of the cavity structure. The housing 1 can also be a space curved structure composed of a space curved template and edge components. The cold compress component, the massage component and the control module 3 are provided in an enclosed space of the space curved template. The side surface of the housing 1 can be the side surface of the space curved template facing away from the enclosed space, or a structural surface of the edge component. That is, regardless of the specific structure of the housing 1, the inside of the housing 1 only indicates that the housing 1 is used as the installation carrier and provides the installation space in which the cold compress component, the massage component and the control module 3 are provided. The side surface of the housing 1 refers to the structural surface of the housing 1 that can not be shielded by other components and can be exposed during the use of the product. The side surface is provided with the cold compress area 2 means that all or part of the side surface can be used to fit on breasts and apply cold compress to breasts, that is, the housing 1 can be regarded as a traditional cold compress, and the cooled cold compress area 2 is directly attached to breasts to cold compress on breasts.

The present application does not specifically limit the cooling method of the cold compress component. In this embodiment, the cold compress component includes a semiconductor refrigeration piece 4, and a cold end of the semiconductor refrigeration piece 4 is abutted against the cold compress area 2. A heat dissipation hole 5 is provided on the side surface of the housing 1 opposite to the cold compress area 2. The heat dissipation hole 5 is provided corresponding to the semiconductor refrigeration piece 4. The cold compress component also includes a metal heat dissipation rack 6. One end of the metal heat dissipation rack 6 is in abutted against the hot end of the semiconductor refrigeration piece 4, and the other end of the metal heat dissipation rack 6 is provided with a heat dissipation fan 7. The use of the semiconductor refrigeration piece 4 is conducive to miniaturization of the structure and is easy to install in the housing 1, no refrigerant is required, safe and pollution-free, no vibration, no noise, with fast cooling speed, and easy to control. The metal heat dissipation rack 6 conducts the heat from the hot end of the semiconductor refrigeration piece 4 to the heat dissipation fan 7 through the metal heat dissipation rack 6. After forced exhausting through the heat dissipation fan 7, the heat is finally discharged out of the housing 1 from the heat dissipation holes 5, which can prevent heat from accumulating in the housing 1, improve the heat dissipation efficiency, and help ensure the cooling effect of the semiconductor refrigeration piece 4, thereby ensuring the cold compress effect and improving the user's experience.

It can be understood that both the massage surface and the cold compress area 2 need to be configured according to the characteristics of breasts and have certain configuration requirements. In this embodiment, one side surface of the housing 1 is configured as a massage surface (the lower side surface in FIG. 2 and FIG. 3), the massage surface includes the cold compress area 2, and the cold compress area 2 is provided at one end of the massage surface. In this way, the side surface of the housing 1 is configured as the massage surface including the cold compress area 2, and the cold compress area 2 is part of the massage surface. The side surface can meet the requirements of massage and cold compress at the same time. Compared with separately setting the massage surface and the cold compress area 2, it can reduce the difficulty of overall product configuration and reduce product manufacturing costs. It should be supplemented that the massage surface refers to the structural surface of the housing 1 that is in contact with breasts during the use of the product. This structural surface can act on breasts to massage and stimulate breasts. The specific shape of the massage surface is not limited, as long as it meets the massage function requirements. It can be understood that the massage surface is a generally smooth surface, such as a flat surface, a hemispherical surface, a drop-shaped surface, and a smooth arc-shaped surface with a certain arc that matches the surface shape of breasts.

In this embodiment, the massage component is a vibration massage component. The vibration massage component includes a vibration motor 8. The vibration motor 8 is provided in the housing 1. It can be understood that the vibration motor 8 is provided in the housing 1, the vibration motor 8 can drive the breast massager 100 to vibrate as a whole, thereby vibrating breasts through the massage surface to massage the breasts and promote milk discharge.

In this embodiment, the massage component is provided at one end of the housing 1 away from the cold compress component. In this way, the mutual interference between the massage component and the cold compress component can be avoided, and the product structure is more reasonable and safer to use.

The specific form of the massage component is not limited in the present application. In an embodiment, the massage component is a kneading massage component, and the kneading massage component includes a kneading portion that can be used to knead breasts. In this way, it can produce a greater stimulation to breasts, relieve the pain, and achieve a better massage effects. Specifically, the kneading massage component may include a motor and a massage wheel. The massage wheel is rotatably mounted on the housing 1. The motor drives the massage wheel to rotate, so that the massage wheel forms the kneading portion. One side surface of the massage wheel is abutted against breasts and rolls on breasts to knead. The kneading massage component may also include a motor, a cam transmission mechanism and a deflection structure. The motor drives the cam transmission structure to rotate, thereby driving the deflection structure to deflect and swing. The deflection structure forms the kneading structure and is abutted against breasts and squeezes and rubs to knead. That is, the kneading massage component is a mechanical massage, and the kneading portion refers to a structure that can be displaced relative to the housing 1, and the kneading is realized by the squeezing and friction of the kneading portion on breasts.

In an embodiment, the massage component is an electrical stimulation massage component, and the electrical stimulation massage component includes an electrical stimulation electrode, and the electrical stimulation electrode can deliver the electrical stimulation to breasts. In this way, by applying a pulse current to breasts, the blood circulation of the breast is accelerated and the pain is relieved. The electrical stimulation can avoid mechanical damage to the breast skin, which is safer and more comfortable.

In order to occupy the breast massager 100 with a hot compress function, in this embodiment, the massage surface also includes a warm compress area 9, and the breast massager 100 also includes a heating piece 10 provided in the housing 1. The heating piece 10 is abutted against the warm compress area 9 and is electrically connected to the control module 3. In this way, the user can directly use the warm compress area 9 of the massage surface to apply a hot compress to breasts to help with the drainage of breasts, which solves the problem of breast congestion and improve the user's experience.

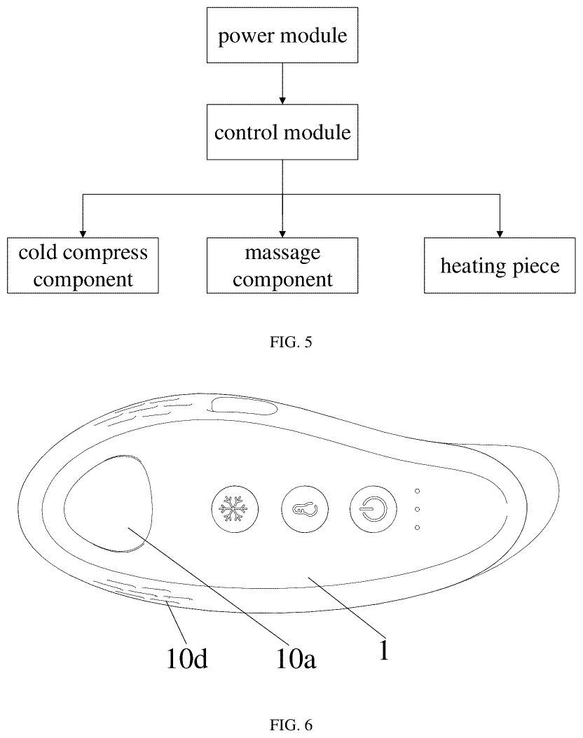

It should be pointed out that, as shown in FIG. 5, the heating piece 10, the massage component, and the cold compress component can be controlled independently, so that the hot compress, the massage, and the cold compress functions of the breast massager 100 can be used independently without interfering with each other. It can be understood that the side area of the housing 1 is limited, and the massage surface includes the cold compress area 2 and a warm compress area 9. The massage surface can satisfy the three functions of massage, cold compress, and hot compress. Compared with configuring the three functions separately, integrating three functions on one side surface can reduce the overall configuration difficulty of the product, leave more space for the configuration of other components of the product. For example, in an embodiment, the breast massager 100 is configured with a button 13 to facilitate users to make targeted selections. In addition, whether it is the massage surface, the cold compress area or the warm compress area, these three surfaces are all used closely with breasts. They have common features in the overall configuration requirements (such as smoothness). The three functions are integrated on one side surface, which also helps to reduce production costs.

In order to miniaturize and visualize the circuit and optimize the electrical layout, in an embodiment, the control module 3 is a printed circuit board (PCB).

In this embodiment, the housing 1 is provided in a curved body structure, and the massage surface is provided on the concave side of the curved body structure (the lower side in FIG. 2 and FIG. 3). On the one hand, the massage surface is made more suitable for the shape of breasts. On the other hand, the housing 1 with the curved structure can be held in hand or inserted between breasts and the underwear, which is more flexible to use.

Further, from a middle position of the curved body structure toward both ends of the curved body structure (the left and right ends in FIG. 2 and FIG. 3), a distance between the concave side of the curved body structure and the convex side of the curved body structure decreases, and one end of the curved body structure is configured as a pushing and scraping corner portion 16. In this way, the pushing and scraping corner portion 16 formed at one end of the curved body structure can occupy the breast massager 100 with a pushing and scraping function. When expelling milk, the user can hold the massager to push and scrape from the position of the mammary gland toward the nipple to promote lactation.

In this embodiment, referring to FIG. 3, the breast massager 100 also includes a power module (see battery 14). The power module supplied power for the massage component, the cold compress component, and the control module 3. The housing 1 includes an inner housing 11 and an outer housing 12 sleeved on the inner housing 11. In an embodiment, the outer housing 12 is configured to be made of liquid silicone corresponding to the massage surface. The liquid silicone material is soft, safe and non-toxic, which can ensure the safety of the product and improve the user's experience during massage. In an embodiment, the housing 12 is configured to be made of liquid silicone corresponding to the squeegee corner 16. The liquid silicone is soft, safe and non-toxic, which can ensure the safety of the product and improve the user's experience during pushing and scraping. In an embodiment, the outer housing 12 is configured as a metal sheet corresponding to the cold compress area 2, so as to ensure a cool feeling during cold compress. It can be understood that the metal sheet should be made of safe and non-toxic metal materials, such as stainless steel, aluminum alloy, etc. One, two, or all of the above three embodiments may exist at the same time. It can be understood that the best effect will be achieved if they exist at the same time. Specifically, the inner housing 11 and other parts of the outer housing 12 can be made of plastic to meet the strength and shape requirements.

In this embodiment, the power module is a battery 14, and the battery 14 supplies power to the massage component, the cold compress component, and the control module 3, so that the breast massager 100 can be used without being connected to power, which is more convenient. More specifically, the battery 14 is a rechargeable battery, and the breast massager 100 is provided with a charging port 15. The battery 14 is charged through the charging port 15. Compared with using disposable batteries, it is more economical and environmentally friendly, which can guarantee the electrical power and power supply.

The breast massager in the present application can be a comprehensive massager with cold compress function combined with at least one of the warm compress function, kneading function, vibration massage function, and electric stimulation massage function, and can provide users the massage or physical therapy with a variety of different functions. The breast massager in the present application can be used in conjunction with a breast pump product. For example, while the breast pump is sucking milk, the hand-held massager can apply physical therapy to the breast along the breast from side, top, and bottom of the breast to promote lactation, prevent milk blockage and relieve pain. In an embodiment, the product is roughly in the shape of a long strip. The user can hold the outer housing 12 to perform massage, warm compress or physical therapy on the breast. The corresponding physiotherapy structure is provided on the surface of one side of the outer housing 12, and the surface of the other side of the outer housing 12 is provided with function button, allowing users to automatically switch between function mode and gear mode according to needs.

In the related art, breast massagers are usually equipped with multiple treatment portions to achieve different functions, but these treatment portions are prone to mutual interference when working at the same time. For example, if the cold compress area and the hot compress area are in the same direction, the heat conduction will cause the cold compress effect to weaken; when the vibration massage and the temperature treatment are superimposed, mechanical movement may affect the uniformity of the temperature distribution. Such problems limit the comprehensive application of the device in multiple scenarios and cannot meet the user's demand for synchronous treatment.

In order to solve the above problems, it is observed that the core reason for the mutual interference of treatment functions of existing devices lies in the spatial overlapping of treatment areas. Through analysis, it is found that if treatment portions with different functions are distributed in different directions of the device, the physical isolation can effectively block the energy transfer path. Based on this, the housing is designed as a multi-faceted structure so that the cold compress and other treatment functions act on independent areas respectively, and at the same time form a natural isolation barrier through orientation differences.

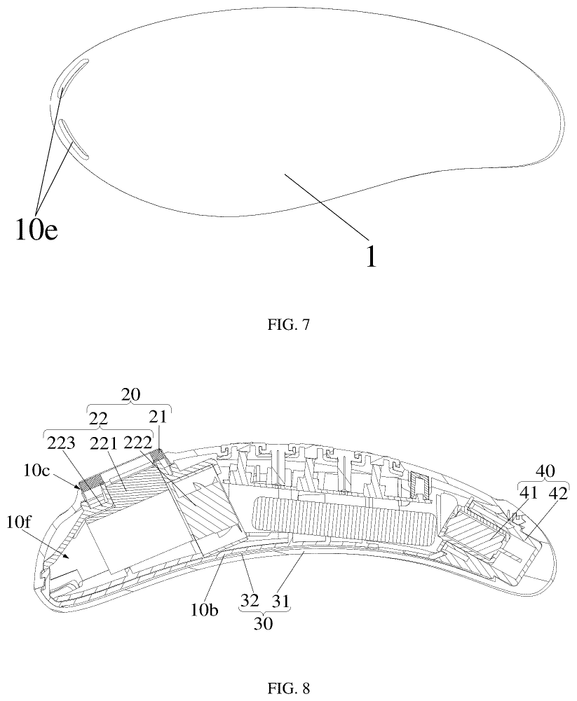

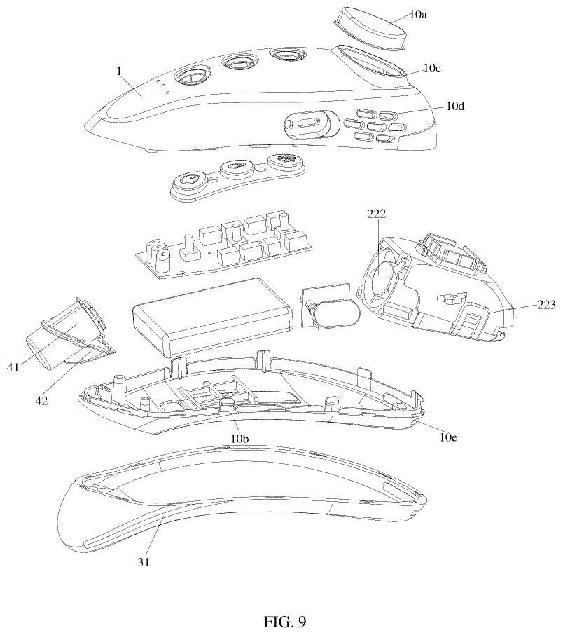

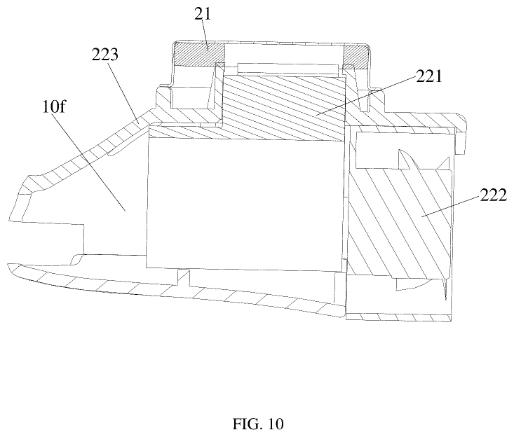

Therefore, referring to FIG. 6 to FIG. 10, the present application provides a breast massager, including a housing 1, and the housing 1 is provided with two contact surfaces with different orientations, which are a first contact surface and a second contact surface. The first contact surface is provided with a first treatment portion 10a, and the second contact surface is provided with a second treatment portion 10b, and at least one treatment portion is a cold compress treatment portion. The two contact surfaces are staggered in spatial orientation to ensure that the treatment functions do not interfere with each other when being implemented.

It should be noted that the simultaneous implementation of the treatment function by the first treatment portion and the second treatment portion does not specifically refer to the situation that the first treatment portion and the second treatment portion must implement the treatment function to the breast at the same time, it may refer to the situation that the duration of the functions of the two treatment portions overlaps in time, one of which is applied to the breast, and the other of which has not been applied to the breast and is in a preheating or precooling state. For example, the user initially applies the hot compress function to the breast and sticks the first treatment portion of the hot compress function on the breast. In order to precool the second treatment portion of the cold compress function in advance, the second treatment portion with the cold compress function is started during the process of applying hot compress to the breast. However, the second treatment portion with the cold compress function may not act on the breast at this time, but is only precooled on another surface that is not in contact with the breast. When the user needs to switch to the cold compress function, the user can directly flip the massager or change the angle of the massager to quickly use the precooled cold compress function, so that the pain is quickly relieved without having to spend a long time waiting for the cold compress temperature to reach the expected temperature, thereby improving the user's experience.

In this embodiment, the housing 1 refers to the support structure that wraps the internal component of the device, and can be designed in a curved surface or split type. For example, it is injection molded by medical-grade plastic, and its surface curvature can adapt to the curve of the breast of the human body. The contact surface refers to the functional area that is in direct contact with the human body. For example, the first contact surface can be located at the top plane of the housing 1, and the second contact surface is located at the side inclined surface of the housing 1. The cold compress treatment portion refers to a module that realizes the cooling function through temperature conduction. Different orientation directions refer to the spatial angle formed by two contact surfaces, for example: the vertical direction and the horizontal direction, two parallel planes or two non-parallel planes, and a physical isolation area is formed by the orientation difference.

When the breast massager is working, the cold compress treatment portion of the first contact surface reduces the temperature of the contact surface through the refrigeration piece 21, and performs cold compress to the breast locally; the treatment portion of the second contact surface can perform hot compress or vibration massage at the same time. Since the two contact surfaces are towards different directions, the cold compress area is spatially isolated from the heat source or the vibration source, blocking the heat transfer path and preventing the cold compress area from being heated or vibrated to affect the temperature stability. For example, when the top contact surface of housing 1 is cold compressed, the hot compress heat of the side contact surface is blocked by the internal insulation layer of housing 1 and only acts on the side area, thereby realizing the synchronous and independent operation of the two treatment functions.

In other embodiments, the orientation of the first contact surface and the second contact surface is not limited to the orientation mentioned above.

The traditional device arranges multiple treatment portions in the same plane, resulting in mutual influence of cold and heat conduction or mechanical vibration.

Through the above technical solution, this solution separates the treatment portions of different treatment functions in physical space by setting the first contact surface and the second contact surface in different positions of the housing 1, fundamentally eliminating functional interference, so that users can enjoy the dual treatment of the cold compress and the hot compress at the same time, or the combined treatment of the cold compress and the vibration massage, so that multiple treatment portions will not interfere with each other when implementing treatment at the same time, ensuring that the cold compress and other treatment functions operate independently, meeting the user's demand for efficient and comfortable treatment experience, and improving treatment efficiency and comfort. In addition, no additional isolation components are needed to achieve the functional isolation of different treatment portions, reducing the manufacturing cost and structural complexity of the device.

Referring to FIG. 6 to FIG. 9, in an embodiment, the first treatment portion 10a is the cold compress treatment portion and the second treatment portion 10b is the hot compress treatment portion.

In this embodiment, the cold compress treatment portion refers to a component that realizes a local cooling function by lowering the temperature of the contact surface. Specifically, it can be realized by using a semiconductor refrigeration piece 21 combined with a heat dissipation module 22, and heat is transferred from the contact surface to the external environment by active cooling. The hot compress treatment portion refers to a component that realizes a local heating function by raising the temperature of the contact surface. Specifically, it can be realized by using a resistance heating element or a far-infrared heating film, and the target area is heated by converting electrical energy into thermal energy.

Specifically, the cold compress treatment portion and the hot compress treatment portion are respectively provided at two contact surfaces of the housing 1 in different directions. When the device is working, the cold compress treatment portion and the hot compress treatment portion act on adjacent or different areas of the breast respectively. Since the cold compress treatment portion and the hot compress treatment portion are located in different spatial directions of the housing 1, the low temperature area generated by the cold compress and the high temperature area generated by the hot compress are physically isolated. The heat of the cold compress treatment portion is discharged to the external environment through the heat dissipation module 22, while the heat of the hot compress treatment portion is concentrated in the target area through heat conduction. There is no direct heat transfer path between the cold compress treatment portion and the hot compress treatment portion, thereby avoiding the mutual cancellation or interference of the cooling and heating.

Referring to FIG. 6 to FIG. 9, in an embodiment, the breast massager includes a cooling apparatus 20 provided inside the housing 1 and connected to the cold compress treatment portion. The breast massager includes a heating apparatus 30 provided inside the housing 1 and connected to the hot compress treatment portion.

In this embodiment, the cooling apparatus 20 refers to a component that realizes the cold compress function by active cooling. The heating apparatus 30 refers to a component that generates heat energy through electrothermal conversion. Specifically, the cooling apparatus 20 and the heating apparatus 30 are respectively integrated in independent functional areas of the housing 1. The two sets of devices form an independent temperature control system through the physical separation of the housing 1, and the cooling circuit and the heating circuit are kept at a distance in the spatial layout to avoid cross-influence of cold and hot energy during the conduction process.

The cooling and heating modules in the traditional device share the same installation space, resulting in mutual interference of the temperature field. In this solution, the cooling apparatus 20 and the heating apparatus 30 form physically isolated independent working units through the functional zoning design inside the housing 1, realizing the parallel operation of the cold compress and hot compress functions. The cold compress function maintains a low temperature state through active heat dissipation, and the hot compress function maintains a constant temperature through closed heat conduction. The cold compress function and the hot compress function realize collaborative work under the spatial isolation state, improving the composite treatment effect while ensuring the safety of the device operation.

Referring to FIG. 6 to FIG. 10, in an embodiment, the cooling apparatus 20 includes a refrigeration piece 21 and a heat dissipation module 22. The refrigeration piece 21 is provided in the housing 1 and connected to the cold compress treatment portion. The heat dissipation module 22 is connected to the end of the refrigeration piece 21 away from the cold compress treatment portion, and is configured to dissipate the heat generated by the refrigeration piece 21.

In this embodiment, the refrigeration piece 21 refers to a semiconductor device for realizing temperature difference power generation based on the Peltier effect. Specifically, it can be realized by using a semiconductor refrigeration piece 21 with a double-sided metal ceramic package, the cold end of which is in contact with the cold compress treatment portion to transfer cooing, and the hot end is connected to the heat dissipation module 22 to extract heat. The heat dissipation module 22 refers to an active heat conduction component, which can be realized by combining an aluminum heat dissipation piece 221 with an axial flow fan 222. The heat dissipation piece 221 is attached to the hot end of the refrigeration piece 21 through thermal grease, and the fan 222 drives the airflow to accelerate the heat exchange at the surface of the heat dissipation piece 221.

Specifically, the cold end of the refrigeration piece 21 is in direct contact with the cold compress treatment portion to form a cold transfer path, so that the temperature of the cold compress area is quickly reduced to the target range. The heat generated by the hot end of the refrigeration piece 21 increases the heat dissipation area through the heat dissipation piece 221, and the heat is discharged out of the housing 1 through the forced convection of the fan 222. The spatial separation layout of the refrigeration piece 21 and the heat dissipation module 22 forms a physical isolation in the opposite direction of heat conduction, which prevents heat from being reversely conducted to the cold compress area through the material of the housing 1. The exhaust direction of the fan 222 in the heat dissipation module 22 can be perpendicular to the surface of the heat dissipation piece 221. For example, the centrifugal fan 222 is configured to axially discharge the hot air in the gap of the heat dissipation piece 221, thereby establishing an efficient heat dissipation channel from the hot end of the refrigeration piece 21 to the outside of the housing 1.

In this solution, a spatially isolated thermal management path is formed between the cold compress area and the heat dissipation area through the directional heat conduction design of the refrigeration piece 21 and the heat dissipation module 22, and the heat exchange efficiency is improved through the forced convection heat dissipation at the same time, thereby achieving the dual effects of stable operation of the cold compress function and parallel non-interference of multiple treatment functions.

Referring to FIG. 6 to FIG. 9, in an embodiment, the heating apparatus 30 includes a hot compress outer shell 31 and a heating member 32, the hot compress outer shell 31 is connected to the housing 1 and is spaced apart from the cooling apparatus 20, and the heating member 32 is provided between the inner wall of the hot compress outer shell 31 and the housing 1.

In this embodiment, the hot compress outer shell 31 refers to a heat transfer component configured to wrap the heating member 32 and contact with breasts, which is connected with housing 1 to form an independent cavity, and blocks the heat exchange path with the cooling apparatus 20 through physical separation. The heating member 32 refers to a component that generates heat, and specifically can be attached to the inner wall of the hot compress outer shell 31 using electric heating wire or carbon fiber heating film. The heat is evenly conducted to the contact surface through the hot compress outer shell 31, and the thermal resistance characteristics of the material of the housing 1 can inhibit heat from diffusing towards the cooling apparatus 20.

Specifically, the hot compress outer shell 31 is fixedly connected to the housing 1 through a bolt or a buckle structure, and an interlayer space is formed between the hot compress outer shell 31 and the housing 1. The heating member 32 is encapsulated in the interlayer space, and the heat directly acts to the breast tissue through the outer surface of the hot compress outer shell 31. The cooling apparatus 20 is provided in the area on the other side of the housing 1, and is spaced apart from the hot compress outer shell 31. The spaced area is filled with insulation material to form a thermal resistance barrier. When the heating member 32 is powered on, the heat is limited to be transferred directionally in the interlayer space between the hot compress outer shell 31 and the housing 1, so as to avoid the lateral heat conduction affecting the heat dissipation efficiency of the cooling module.

The traditional solution arranges the hot and cold modules in adjacent areas, resulting in cross interference of heat flow, while the present solution forms a directional heat transfer channel through the interlayer structure of the hot compress outer shell 31 and the housing 1, and at the same time uses the spacing layout to cut off the direct heat conduction path between the hot and cold modules. In this solution, the heat is only transferred along the direction of the contact surface through a closed interlayer formed by the inner wall of the hot compress outer shell 31 and the housing 1

The heating member 32 can adopt a variety of different heating technologies, such as electric heating wire heating, carbon fiber heating, graphene heating, etc., which has the advantages of fast heating speed, uniform temperature, and long service life. The hot compress component also has a temperature adjustment function. Users can adjust the hot compress temperature through the control panel or the remote control according to their own needs to ensure the comfort and safety of the hot compress process.

The hot compress outer shell 31 is a soft rubber shell made of high-quality medical-grade silicone material with good flexibility and biocompatibility. The soft rubber shell can fit the breast surface tightly to ensure that the heat can be fully transferred to the breast tissue, while also providing a comfortable use experience. The surface of the soft rubber shell has been specially treated and has a certain friction coefficient, which can prevent the hot compress outer shell 31 from sliding during use and ensure the hot compress effect. In addition, the soft rubber shell also has good weather resistance and aging resistance, and can maintain good performance and appearance during long-term use.

Referring to FIG. 6 to FIG. 9, in an embodiment, the first contact surface and the second contact surface are located at two surfaces of the housing 1 which are spaced apart.

In this embodiment, the two surfaces of the housing 1 which are spaced apart refer to two independent areas of the housing 1 that are separated from each other and have a spatial distance. Specifically, the two surfaces can be realized by using planes or curved surfaces at opposite sides of the housing 1, and the two surfaces are physically separated by the internal structure or external contour of the housing 1. The spacing makes the two contact surfaces separated in space to avoid direct contact between the treatment portions.

Specifically, the two contact surfaces are respectively provided in different surface areas of the housing 1. For example, one contact surface is located at the front side surface of the housing 1, and the other contact surface is located at the rear side surface of the housing 1. When the device is working, the two treatment portions act at adjacent or different areas of the breast respectively. Due to the spatial isolation between the contact surfaces, the low temperature of the cold compress treatment portion and the high temperature of the hot compress treatment portion will not be directly transmitted through the material of the housing 1, and the mechanical movement of the vibration treatment portion will not be transmitted to the other treatment portion through the structure of the housing 1. Thus, the two treatment functions form independent action areas in physical space, blocking mutual interference of energy or movement.

Through the above technical solution, the present application realizes the independent operation of the cold compress, the hot compress or the vibration treatment function, ensures the effective transmission of different treatment effects, and avoids the decline of treatment effect caused by temperature neutralization or mechanical interference, thereby improving the comfort and treatment efficiency of users.

In an embodiment, a heat insulation structure is provided between the hot compress treatment portion and the cold compress treatment portion.

In this embodiment, the heat insulation structure refers to a physical isolation component for blocking the heat conduction path, which can be realized by a polyurethane foam layer or a ceramic fiberboard. The structure separates the hot and cold areas into independent temperature zones through a low thermal conductivity material layer, forming a temperature gradient buffer zone inside the device.

Specifically, when the hot compress treatment portion generates heat through the heating apparatus 30, the heat insulation structure inhibits the heat from diffusing to the cold compress treatment portion through the low thermal conductivity of the material. At the same time, when the cold compress treatment portion is maintained at a low temperature through the cooling apparatus 20, the heat insulation structure blocks the cold energy from being transferred to the hot compress area. This structure enables the two treatment portions to maintain temperature stability in their respective closed spaces, avoids cross interference of cold and hot energy through the metal parts of the housing 1 or internal air convection, and enables the cold and hot treatment portions to form independent working units, which can still maintain their respective set temperature ranges during synchronous operation.

Referring to FIG. 6 to FIG. 9, in an embodiment, the first contact surface is provided with a protrusion mounting position 10c, and the protrusion mounting position 10c is provided with the cold compress treatment portion.

The protrusion mounting position 10c refers to a local protrusion structure formed by extending outward from the surface of the housing 1, which can be realized by a hemispherical, cylindrical or arc-shaped boss structure. The structure forms an independent installation area through a physical height difference, which is configured to carry the cold compress treatment portion and isolate it from the adjacent treatment portion. The cold compress treatment portion can transfer cold to the target area in a direction through the bearing positioning of the protrusion mounting position 10c.

In an embodiment, the protrusion mounting position 10c is located at the top surface, the bottom surface or the side surface of the housing 1. The top surface refers to the area where the housing 1 contacts the upper side of the breast, and its curvature is adapted to the upper curve of the human breast. The bottom surface refers to the plane or curved surface area where the housing 1 contacts the lower edge of the breast, which is convenient for adjusting the contact angle according to the user's body. The side surface refers to the outer surface of the housing 1 at both sides or in the front and back directions, so as to be compatible with the installation requirements of refrigeration piece 21 in different sizes.

Specifically, the three-dimensional structure of the protrusion mounting position 10c enables the cold compress treatment portion to form multiple points of contact with the breast surface, thereby increasing the contact pressure to improve the cold conduction efficiency. The edge profile of the protrusion mounting position 10c is adapted to the breast curve, and deforms when pressure is applied to expand the contact surface area. The cold compress treatment portion is embedded with the protrusion mounting position 10c, such as by snapping or bonding, so as to ensure that no displacement occurs during the cold compress process. The height difference of the protrusion mounting position 10c enables the cold compress treatment portion to form a vertical spatial separation with other treatment portions, blocking the heat conduction path and avoiding temperature interference between the cold compress area and the hot compress or the vibration area.

Through the above technical solution, the cold compress treatment portion of the present application obtains stable positioning support through the protrusion mounting position 10c, improves the cold transfer efficiency under the action of the contact pressure, and maintains its own temperature stability through spatial isolation. This structural design enables multiple treatment functions to work in parallel within a limited space, solving the problems of cold and heat cancellation and vibration conduction interference caused by the plane layout of the traditional device.

Referring to FIG. 6 to FIG. 9, in an embodiment, a plurality of protrusion mounting positions 10c are provided at the surface of the housing 1, and each of the protrusion mounting positions 10c is provided with the cold compress treatment portion.

In this embodiment, that the protrusion mounting positions 10c are provided at the surface of the housing 1 mean that the plurality of protrusion mounting positions 10c are distributed in the area where the housing 1 contacts the breast according to a preset spacing, such as a matrix arrangement or a ring distribution. Its function is to adapt to the curved surface of the breast through the spatial layout to ensure that the cold compress action point is effectively fitted with the skin in different areas. Through the above technical solution, the present application can expand the scope of cold compress to multiple target areas of the breast, realize accurate cold compress with multi-point independent temperature control, and suppress the diffusion of cold through the interval layout of protrusion mounting position 10c at the same time, ensuring that each of the cold compress treatment portions operates stably without interfering with each other.

The plurality of protrusion mounting positions 10c are distributed at the surface of the housing 1 at intervals, such as the top and side positions, and the cold end of refrigeration piece 21 is independently installed at each position, so that breast parts in different areas can receive cold compress at the same time. The hot end of refrigeration piece 21 is inserted into the common ventilation path 10f, and the airflow driven by the fan 222 absorbs heat from the air intake hole 10d and discharges the heat through the heat dissipation hole 10e, realizing centralized treatment of heat from the plurality of refrigeration pieces 21. The design of each of the protrusion mounting positions 10c connected to the ventilation path 10f enables the low temperature generated by the cold end to be directly transferred to the human body, and the heat of the hot end is uniformly discharged, avoiding local heat accumulation and affecting the cooling efficiency.

Specifically, the plurality of protrusion mounting positions 10c form discretely distributed cold compress action points at the surface of housing 1, and the cold compress treatment portion independently provided inside each of the protrusion mounting positions 10c generates low temperature through the refrigeration piece 21, and transfers the cold to the contact surface of the protrusion mounting position 10c through the heat conductive layer.

In an embodiment, the metal heat conductive plate of the protrusion mounting position 10c can be wrapped with a flexible silicone material to enhance the contact comfort with the skin. The refrigeration piece 21 of the cold compress treatment portion can be independently connected to the control circuit to achieve differentiated temperature regulation of different protrusion mounting positions 10c.

Referring to FIG. 6 to FIG. 9, in an embodiment, the cold compress treatment portion is located at one end of the housing 1.

In this embodiment, one end of the housing 1 refers to the end portion of the overall structure of the housing 1 that is away from the central area. When the cold compress treatment portion is provided at the end area of the housing 1, a clear spatial separation is formed between the cold compress treatment portion and the hot compress or the vibration treatment portion at other areas of the housing 1. This position design reduces the possibility of temperature conduction or mechanical vibration transmission by increasing the physical distance between the cold compress area and other treatment areas. For example, when the hot compress treatment portion is located at the middle of the housing 1, the cold compress treatment portion operates independently at the end of the housing 1, and the structure of the housing 1 between the hot compress treatment portion and the cold compress treatment portion can block the heat diffusion path; when the vibration treatment portion is located at the other side of the housing 1, the cold compress treatment portion at the end of the housing 1 will not be affected by vibration conduction. As a result, different treatment functions are isolated in space to avoid the reduction of treatment effect caused by temperature interference or mechanical interference.

In this solution, the cold compress treatment portion is independently provided at the end of the housing 1, and the isolation barrier is formed through the structure of the housing 1, so that the cross-interference between different treatment functions is fundamentally eliminated.

Referring to FIG. 6 to FIG. 10, in an embodiment, the housing 1 is also provided with an air intake hole 10d and a heat dissipation hole 10e communicated with the external environment, and a ventilation path 10f is formed between the air intake hole 10d and the heat dissipation hole 10e. The heat dissipation module 22 includes a heat dissipation piece 221 and a fan 222, and the heat dissipation piece 221 is connected to the refrigeration piece 21. Both the heat dissipation piece 221 and the fan 222 are located at the ventilation path 10f, and the fan 222 is configured to dissipate the heat of the heat dissipation piece 221 to the external environment.

In this embodiment, the air intake hole 10d refers to an airflow inlet opened at the surface of housing 1, which can be realized by a circular array hole or a strip grid structure, and is configured to introduce external air to form an airflow cycle. The heat dissipation hole 10e refers to an airflow outlet opened at the surface of housing 1, which can be realized by a hole structure symmetrically distributed with the air intake hole 10d, and is configured to define the airflow movement direction together with the air intake hole 10d. The ventilation path 10f refers to an air flow channel from the air intake hole 10d to the heat dissipation hole 10e, which can be realized by a combination of the internal cavity of housing 1 and the guide structure to form a heat exchange space independent of the treatment area. The heat dissipation piece 221 refers to a heat-conducting component with an extended surface area, which can be realized by an aluminum fin structure, and is configured to improve heat dissipation efficiency by increasing the contact surface area with the airflow. The fan 222 refers to an active airflow driving device, which can be realized by an axial flow fan 222 or a centrifugal fan 222, and is configured to accelerate heat discharge by the forced convection.

Specifically, when the refrigeration piece 21 is working, the heat generated is transferred to the ventilation path 10f through the heat dissipation piece 221. After the fan 222 is started, negative pressure is generated, and the outside air enters from the air intake hole 10d and flows through the surface of the heat dissipation piece 221, absorbing the heat of the heat dissipation piece 221 to form a high-temperature airflow. Finally, the air is discharged from the device through the heat dissipation hole 10e. In this process, the ventilation path 10f completely isolates the heat dissipation area from the treatment area of the housing 1 that contacts the breast, preventing the heat from being transferred through the housing 1 to affect the cold compress effect. The synergistic effect of the heat dissipation piece 221 and the fan 222 forms a directional heat flow, ensuring that the temperature of the hot end of the refrigeration piece 21 is always lower than the critical value. The physical separation design of the internal space of the housing 1 ensures that the mechanical energy generated by the vibration module does not interfere with the airflow movement in the ventilation path 10f.

The traditional device usually arranges the heat dissipation component and the treatment portion in the same cavity, resulting in the mixing of the heat dissipation airflow with the air inside the device to form a heat cycle. This solution achieves directional heat discharge by constructing the independent ventilation path 10f, eliminates the heat retention phenomenon inside the device, effectively isolates the heat exchange between the heat dissipation process and the cold compress treatment area, and prevents the heat generated by the refrigeration piece 21 from being transferred to the contact surface through the housing 1. The efficient operation of the heat dissipation module 22 reduces the heat accumulation inside the device and provides a more stable working environment for the vibration massage module. The functional zoning design of the structure of the housing 1 fundamentally solves the mutual interference problem when multiple treatment functions are operated at the same time.

Referring to FIG. 6 to FIG. 10, in an embodiment, the heat dissipation module 22 also includes an air duct housing 223 installed in the housing 1, and the air duct housing 223 is connected to the hot end of the refrigeration piece 21. The air duct housing 223 is communicated with the air intake hole 10d and the heat dissipation hole 10e, and the ventilation path 10f is formed. The outer wall of the fan 222 is sealed against the inner wall of the air duct housing 223, so as to drive the fresh air to flow from the air intake hole 10d, the ventilation path 10f and the heat dissipation hole 10e in sequence.

In this embodiment, the air duct housing 223 refers to a specific structural component installed inside housing 1, which can be made of a material with certain strength and heat resistance, such as aluminum alloy, to ensure that it can withstand the impact of airflow and heat transfer, and achieve close connection with the hot end of the refrigeration piece 21 through precise processing technology, so as to efficiently introduce the heat generated by the hot end of the refrigeration piece 21 into the air duct housing 223. The shape and size of the air duct housing 223 can be optimized according to the internal space and heat dissipation requirements of the housing 1, and the internal structure of the air duct housing 223 corresponds to the air intake hole 10d and the heat dissipation hole 10e to construct a complete ventilation path 10f, providing a stable channel for the orderly flow of airflow.

As the core component of the airflow drive, the outer wall of the fan 222 and the inner wall of the air duct housing 223 are sealed and abutted. This sealing and abutting can be achieved by installing a rubber sealing ring, applying sealant, etc., to ensure that the airflow will not leak out from the gap between the fan 222 and the air duct housing 223 during the operation of the fan 222, so as to ensure that the airflow can flow along the predetermined path. When the fan 222 is started, the negative pressure generated by the fan acts at the air inlet end of the ventilation path 10f, prompting the fresh air from the outside to flow in continuously from the air intake hole 10d. The airflow flows smoothly along the ventilation path 10f constructed by the air duct housing 223, passing through the air intake hole 10d, the ventilation path 10f and the heat dissipation hole 10e in turn, and finally the high-temperature gas after absorbing heat is discharged to the outside of the device, which effectively improves the efficiency and accuracy of the heat dissipation, ensures that the heat generated by the refrigeration piece 21 during operation can be dissipated in time, and maintains its good working condition.

In this solution, the air duct housing 223 is provided in the housing 1, the fan 222 is sealed and abutted against the air duct housing 223, and an independent and efficient ventilation and heat dissipation channel is constructed, so that the fresh air can flow in an orderly manner and take away heat, greatly enhancing the performance of the heat dissipation module 22, and providing a strong guarantee for the stable operation of the entire device.

In an embodiment, the air duct housing 223 is provided with an installation port communicated with the protrusion mounting position 10c and the ventilation path 10f, and the periphery of the installation port is provided with an installation rib. The refrigeration piece 21 is installed in the protrusion mounting position 10c and fixed to the installation rib. The installation port refers to the opening area where the air duct housing 223 is communicated with the external structure, which can be realized by a rectangular or circular through-hole structure. The opening passes through the space of the ventilation path 10f and the protrusion mounting position 10c, and is configured to form a docking relationship with the refrigeration piece 21. The installation rib refers to a raised structure extending around the edge of the installation port, which can be specifically realized by injection-molded annular ribs. The structure constrains the installation position of the refrigeration piece 21 through mechanical limit. The limit fixation refers to limiting the spatial freedom of the refrigeration piece 21 through a rigid contact surface, which can be specifically realized by the interference fit between the inner wall of the rib and the outer edge of the refrigeration piece 21, so that the refrigeration piece 21 is completely constrained in the vertical direction.

During the installation process, the refrigeration piece 21 is first placed at the protrusion mounting position 10c, and is fixed and limited through the installation rib. The shape and size of the installation rib is matched with the shape of the refrigeration piece 21, which can ensure that the refrigeration piece 21 is effectively constrained in all directions. In addition, the design of the installation port also facilitates the removal and replacement of the refrigeration piece 21. When the refrigeration piece 21 needs to be maintained or replaced, the refrigeration piece 21 can be easily removed by loosening the installation rib, which is simple and quick to operate.

Referring to FIG. 6 to FIG. 10, in an embodiment, the exhaust side of the fan 222 is towards the heat dissipation piece 221.

In this embodiment, the exhaust side refers to the side where the air outlet direction of the fan 222 is located, which can be specifically realized by the exhaust port of the axial flow fan 222 or the centrifugal fan 222, and is configured to direct the airflow to the surface of the heat dissipation piece 221. Specifically, the airflow generated when the fan 222 is in operation directly acts at the surface of the heat dissipation piece 221 from the exhaust side, and the airflow flows along the surface of the heat dissipation piece 221 and takes away the heat. Since the exhaust side of the fan 222 and the heat dissipation piece 221 form a directional convection path, the heat absorbed by the heat dissipation piece 221 is forced to be discharged to the external environment to avoid heat accumulation inside the device. The contact efficiency between the surface of heat dissipation piece 221 and the air is improved by the directional flow of airflow, and the heat generated by the hot end of the refrigeration piece 21 is continuously discharged, thereby reducing the thermal interference to the cold compress treatment portion.

This solution adjusts the direction of the exhaust side of the fan 222, so that the airflow acts on the surface of the heat dissipation piece 221, strengthens the cooperative heat dissipation ability of the heat dissipation piece 221 and the fan 222, and solves the mutual interference problem caused by insufficient heat dissipation of multiple treatment modules.

Referring to FIG. 6 to FIG. 10, in an embodiment, the housing 1 is provided in a curved structure, the bottom of housing 1 is the concave side of the curved structure, and the second treatment portion 10b is provided at the concave side.

In this embodiment, the curved structure refers to that the housing 1 as a whole presents a non-planar shape that conforms to ergonomics, which can be achieved by a single arc surface or a combination of composite arc surfaces. The structure adapts to the curve of the human body through the shape, so that the device forms a uniform pressure distribution when it contacts the skin. The concave side refers to the accommodation space formed by the inward bending of the bottom of the housing 1, which can be realized by a groove structure formed by an injection molding process. The concave area provides an independent installation position for the second treatment portion 10b to avoid spatial overlapping with other functional modules. The second treatment portion 10b refers to a treatment component with cold compress, hot compress or vibration functions, which can be realized by the semiconductor refrigeration piece 21, the electric heating film or the micro vibration motor and other components. The component blocks the heat conduction or mechanical vibration transmission path with other treatment portions through the physical isolation layout of the concave side.

Specifically, the housing 1 with a curved structure forms a matching contact with the breast contour of the human body through its curvature, and the independent space formed at the concave side physically separates the second treatment portion 10b from other functional modules. When the device is working, the cold or heat generated by the second treatment portion 10b at the concave side is limited to the area where it is located, and the continuous surface of the curved structure blocks the direct contact between different treatment portions. This spatial separation mechanism allows the cold compress and massage functions to operate simultaneously without thermal or mechanical interference, while the curved surface structure improves wearing comfort by dispersing contact pressure.

This solution achieves three-dimensional spatial separation of the treatment function while maintaining the overall compactness of the device through the combination of the curved housing 1 and the concave side structure. The independent operation space of the functional module is achieved through the optimization of the shape of the housing 1, avoiding the offset of the treatment effect caused by temperature conduction. At the same time, the curved surface structure enhances the fit with human tissue and reduces the treatment positioning deviation caused by device displacement.

Referring to FIG. 6 to FIG. 10, in an embodiment, one of the first treatment portion 10a and the second treatment portion 10b is the cold compress treatment portion, and the other of the first treatment portion 10a and the second treatment portion 10b is the massage treatment portion 40.

In this embodiment, the massage treatment portion 40 refers to a component that realizes the massage function through mechanical vibration. Physically isolated functional partitions refer to that the cold compress treatment portion and the massage treatment portion 40 are respectively provided in different areas of the housing 1 to avoid the heat and the mechanical vibration being conducted to each other during operation.

Specifically, the cold compress treatment portion and the massage treatment portion 40 are respectively provided at independent positions of the housing 1, and the cooling energy generated by the refrigeration piece 21 during operation is transmitted to the contact surface through a local area of the housing 1, while the mechanical vibration generated by the vibration motor 41 is transmitted to another area of the housing 1 through the conduction rubber 42. Since the cold compress and massage functions are separated in space, the heat generated by the hot end of the refrigeration piece 21 during the heat dissipation process will not be conducted to the area where the vibration motor 41 is located through the housing 1, and the mechanical vibration of the vibration motor 41 will not interfere with the heat dissipation efficiency of the refrigeration piece 21. As a result, the low temperature environment required for the cold compress and the vibration action required for the massage can be operated synchronously without interfering with each other.

After the cold compress treatment portion is embedded in the protruding structure, the cold end surface of the cold compress treatment portion can directly act at the skin tissue. The massage treatment portion 40 operates in another area of the housing 1, and the mechanical energy generated is conducted to the contact surface through the housing 1, forming a functional partition with the cold compress treatment portion. This layout allows the cold compress and massage functions to operate independently in space, and realize operational integration through the unified housing 1.

This solution uses the physical isolation design of functional partitions to make the cold compress and massage modules completely independent in spatial layout, fundamentally eliminating the mutual interference between the two treatment modes, which ensures the cold compress temperature stability and the regularity of the massage action, thereby improving the composite treatment effect and user comfort.

In an embodiment, the massage treatment portion 40 can adopt a variety of different massage methods, such as vibration massage, kneading massage, electrical stimulation massage, etc., to meet the needs of different users.

In an embodiment, the massage treatment portion 40 is connected to the housing 1 through a special shock-absorbing structure, which can effectively absorb the vibration energy generated during the movement of the massage treatment portion 40, and prevent the vibration from being transmitted to other parts of the housing 1, thereby improving the user comfort.

Referring to FIG. 6 to FIG. 10, in an embodiment, the massage treatment portion 40 includes a vibration motor 41 and a conduction rubber 42. The vibration motor 41 is installed in the housing 1. One end of the conduction rubber 42 is connected to the output shaft of the vibration motor 41, and the other end of the conduction rubber 42 is connected to the housing 1 in a transmission manner. The vibration motor 41 is configured to drive the conduction rubber 42 to vibrate, so that the conduction rubber 42 drives the housing 1 to vibrate, so as to perform a massage operation to the breast.

In this embodiment, the vibration motor 41 refers to a power element that converts electrical energy into mechanical vibration energy, which can be specifically implemented by a micro eccentric rotor motor, and is configured to generate periodic centrifugal force through an output shaft. The conduction rubber 42 refers to a flexible transmission component with elastic deformation ability, which can be specifically made of a columnar or sheet structure made of silicone or rubber material, and realize directional transmission of vibration energy by connecting the vibration source and the load end at both ends.

Specifically, the vibration motor 41 is fixed to an independent mounting position in the inner cavity of the housing 1, and the output shaft of the vibration motor 41 is physically connected to one end of the conduction rubber 42 by a rigid connection or a snap-on method. The other end of the conduction rubber 42 is connected to the inner wall of the housing 1 by an interference fit or bonding method to form a transmission connection. When the vibration motor 41 is started, the high-frequency vibration generated by the output shaft is converted into a low-frequency vibration wave through the elastic deformation of the conduction rubber 42. The material damping characteristics of the conduction rubber 42 can absorb part of the high-frequency harmonic energy and reduce the resonance effect of the housing 1. The housing 1 generates a local reciprocating motion under the traction of the conduction rubber 42, and the motion is limited to the second treatment portion 10b at the concave side of the bottom of the housing 1. The top area of the housing 1 where the cold compress treatment portion is located remains stationary due to the physical isolation of the vibration transmission path.

This technical solution adds an energy attenuation link in the vibration transmission path through the flexible transmission of the conduction rubber 42, so that the vibration energy is limited to a specific area. At the same time, the cold compress and massage functions are decoupled in the spatial dimension through the physical isolation of the bottom recessed side and the top area of the housing 1.

In an embodiment of the present application, the massage treatment portion 40 is a kneading massage component, and the kneading massage component includes a kneading portion configured to perform a kneading action to the breast, so that a greater stimulation can be generated to the breast, pains can be relieved, and a better massage effect can be obtained. Specifically, the kneading massage component can include a motor and a massage wheel, and the massage wheel is rotatably mounted at the housing 1. The motor drives the massage wheel to rotate so that the massage wheel forms the kneading portion, and the side of the massage wheel is abutted against the breast and rolls on the breast to perform the kneading action. Of course, the kneading massage component can also include a motor, a cam transmission mechanism, and a deflection structure. The motor drives the cam transmission structure to rotate, thereby driving the deflection structure to deflect and swing, and the deflection structure forms the kneading portion. The deflection structure is abutted against the breast, and squeezes and rubs on the breast to achieve the kneading action. That is, the kneading massage component can provide a mechanical massage. The kneading portion refers to a structure that can generate displacement relative to the housing 1, and the kneading action is achieved by squeezing and rubbing the kneading portion on the breast.

In an embodiment, the massage treatment portion 40 is an electrical stimulation massage component, and the electrical stimulation massage component includes an electrical stimulation electrode. The electrical stimulation electrode is configured to transmit electrical stimulation to the breast. In this way, by applying pulse current to the breast, the blood circulation of the breast is accelerated, and the pain can be relieved. The electrical stimulation can avoid mechanical damage to the breast skin, and is safer and more comfortable.

It is worth noting that in this embodiment, the breast massager also includes a control module, and the control module includes a printed circuit board (PCB) and a power button, a cold compress button, a heating button, and a massage button control button electrically connected to the PCB. The PCB is electrically connected to the massage treatment portion 40, the cooling apparatus 20, and the heating apparatus 30. The above-mentioned control buttons are provided at the surface of the housing 1, and the user can activate different treatment functions through the control buttons of the cold compress button, the heating button and the massage button, so that the user can make targeted selections. Specifically, when the user presses the cold compress button, the heating button or the massage button, the PCB can receive the corresponding electrical signal and send a control instruction to the massage treatment portion 40, the cooling apparatus 20 or the heating apparatus 30, so that the massage treatment portion 40, the cooling apparatus 20 or the heating apparatus 30 implements the treatment under the control instruction.

The user can implement a single function treatment by pressing a control button among the cooling apparatus 20, the heating apparatus 30 and the massage treatment portion 40; or the user can implement multiple treatment portions to implement treatment at the same time by pressing two or more control buttons at the same time, so that the user can make targeted selections. The cold compress button makes the breast massager produce a cooling effect on one of its surfaces. The heating button makes the breast massager heat one of its surfaces. The massage button makes the breast massager vibrate in a relatively soothing manner so that the user can apply massage to the breast.

The breast massager also includes a power module provided in the housing 1. The power module is electrically connected to the massage treatment portion 40, the cooling apparatus 20, the heating apparatus 30, and the control module, and supplies power to the massage treatment portion 40, the cooling apparatus 20, the heating apparatus 30, and the control module. The power module is a battery, and the battery supplies power to the massage treatment portion 40, the cooling apparatus 20, the heating apparatus 30, and the control module, so that the breast massager can be used without being connected to the mains, and is more convenient to use. More specifically, the battery is a rechargeable battery, and the breast massager is provided with a charging port. The battery is charged through the charging port, which is more economical and environmentally friendly than using disposable batteries, and can also ensure power consumption and power supply.

In an embodiment, the control module includes the PCB and a power button and a function knob electrically connected to the PCB, and the user can select the cold compress function, the hot compress function, or the massage function by rotating the function knob.

In an embodiment, the control module may also include the PCB and an interactive screen electrically connected to the PCB, and the interactive screen displays a virtual cold compress function key, a virtual hot compress function key, or a virtual massage function key, etc. The user can select the corresponding treatment portion to implement the treatment through the virtual cold compress function key, the virtual hot compress function key, or the virtual massage function key at the motor interactive screen.

In an embodiment, the breast massager is provided with the cooling apparatus 20, the heating apparatus 30, and the massage treatment portion 40, and the cooling apparatus 20, the heating apparatus 30, and the massage treatment portion 40 are respectively integrated at the three contact surfaces of the housing 1 to avoid the heat and mechanical vibration being conducted to each other during operation. In an embodiment, the breast massager is provided with two of the cooling apparatus 20, the heating apparatus 30, and the massage treatment portion 40, and the above two devices are also respectively integrated at the two contact surfaces of the housing 1.

The breast massager also includes a data port, which may be a micro-USB or a mini-USB port. Other connection interfaces may also be implemented. The data port enables the transmission and reception of data. For example, the breast massager can be controlled through an external device (such as a smartphone, tablet, smart watch, laptop, or desktop computer) via the data port. In addition, the breast massager can output data about the treatment to the external device, such as the type of the applied treatment, the duration of the treatment, and statistics related to the treatment, such as the temperature applied or the current/voltage applied via EMS or TENS.

In an embodiment, the breast massager does not include a data port, but a wireless communication module is provided in the housing to be electrically connected to the control module. The user can send a control signal to the control module through the wireless communication module, and the wireless communication module can be Bluetooth, NFC or Wi-Fi.

In summary, the breast massager provided in the present application realizes the organic combination of multiple functions such as the cold compress, the hot compress and the massage through innovative design and structural layout. The breast massager can not only effectively relieve breast pain and discomfort, promote breast blood circulation, but also provide users with a more comprehensive and comfortable nursing experience. The collaborative work among various components ensures the stability and reliability of the entire breast massager during use, and has broad application prospects and market value.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A breast massager, configured for applying a treatment function to a breast, comprising a housing, wherein,
the housing comprises a first contact surface and a second contact surface for applying the treatment function to the breast;
the first contact surface comprises a first treatment portion, and the second contact surface comprises a second treatment portion;
at least one of the first treatment portion and the second treatment portion is a cold compress treatment portion for applying a cold compress treatment to the breast; and
the first contact surface and the second contact surface are provided in two different directions of the housing, so that the first treatment portion and the second treatment portion do not interfere with each other when they apply the treatment function to the breast simultaneously.

2. The breast massager according to claim 1, wherein the first treatment portion is the cold compress treatment portion, and the second treatment portion is a hot compress treatment portion.

3. The breast massager according to claim 2, further comprising:
a cooling apparatus; and
a heating apparatus,
wherein the cooling apparatus is provided in the housing and connected to the cold compress treatment portion, and the heating apparatus is provided in the housing and connected to the hot compress treatment portion.

4. The breast massager according to claim 3, wherein the cooling apparatus comprises a refrigeration piece and a heat dissipation module, the refrigeration piece is provided in the housing and connected to the cold compress treatment portion, and the heat dissipation module is connected to one end of the refrigeration piece away from the cold compress treatment portion and is configured for dissipating heat generated by the refrigeration piece.

5. The breast massager according to claim 3, wherein the heating apparatus comprises:
a hot compress outer shell connected to the housing and spaced apart from the cooling apparatus; and
a heating member provided between an inner wall of the hot compress outer shell and the housing, and configured to heat the hot compress outer shell.

6. The breast massager according to claim 1, wherein the first contact surface and the second contact surface are provided at two isolated surfaces of the housing.

7. The breast massager according to claim 2, wherein a heat insulation structure is provided between the hot compress treatment portion and the cold compress treatment portion, and the heat insulation structure is configured to separate the hot compress treatment portion and the cold compress treatment portion.

8. The breast massager according to claim 1, wherein the first contact surface is provided with a protrusion mounting position, and the protrusion mounting position is provided with the cold compress treatment portion.

9. The breast massager according to claim 8, wherein a plurality of protrusion mounting positions are distributed at a surface of the housing, and each of the protrusion mounting positions is provided with the cold compress treatment portion.

10. The breast massager according to claim 1, wherein the cold compress treatment portion is provided at one end of the housing.

11. The breast massager according to claim 4, wherein:
the housing is further provided with an air intake hole and a heat dissipation hole communicated with an external environment, and a ventilation path is formed between the air intake hole and the heat dissipation hole; and
the heat dissipation module comprises a heat dissipation piece connected to the refrigeration piece and a fan, both the heat dissipation piece and the fan are provided in the ventilation path, and the fan is configured to dissipate a heat of the heat dissipation piece to the external environment.

12. The breast massager according to claim 11, wherein:
the heat dissipation module further comprises an air duct housing provided in the housing and connected to a hot end of the refrigeration piece;
the air duct housing is communicated with the air intake hole and the heat dissipation hole to form the ventilation path; and
an outer wall of the fan is sealed and abutted against an inner wall of the air duct housing to drive a fresh air to flow from the air intake hole, the ventilation path and the heat dissipation hole in sequence.

13. The breast massager according to claim 11, wherein a discharge side of the fan is towards the heat dissipation piece.

14. The breast massager according to claim 2, wherein the housing is a curved structure, a bottom of the housing is a concave side of the curved structure, and the second treatment portion is provided at the concave side.

15. The breast massager according to claim 1, wherein one of the first treatment portion and the second treatment portion is the cold compress treatment portion, and another of the first treatment portion and the second treatment portion is a massage treatment portion.

16. The breast massager according to claim 15, wherein the massage treatment portion comprises:
a vibration motor provided in the housing; and
a conduction rubber, wherein one end of the conduction rubber is connected to an output shaft of the vibration motor, and the other end of the conduction rubber is connected to the housing in a transmission manner; and
the vibration motor is configured to drive the conduction rubber to vibrate, so that the housing is driven to vibrate by the conduction rubber to perform a massage operation to the breast.
